(19) United States
(12) Patent Application Publication
(10) Pub. No.: US 2025/0117162 A1
(43) Pub. Date: Apr. 10, 2025

(54) TECHNIQUES FOR STAGGERING DATA BURST EVENTS ACROSS CHANNELS

(71) Applicant: Micron Technology, Inc., Boise, ID (US)

(72) Inventors: Liang Yu, Boise, ID (US); Jonathan S. Parry, Boise, ID (US)

(21) Appl. No.: 18/771,609

(22) Filed: Jul. 12, 2024

Related U.S. Application Data
(60) Provisional application No. 63/588,237, filed on Oct. 5, 2023.

(51) Int. Cl. G06F 3/06

(52) U.S. Cl. CPC G06F 3/0659; G06F 3/0604; G06F 3/0679

(57) ABSTRACT

Methods, systems, and devices for techniques for staggering data burst events across channels are described. A memory system may offset data transfer events over multiple channels with a timing delay between data transfers over respective channels. For example, the memory system may initiate a first data transfer over a first channel at a first time and implement a timing delay before a second data transfer over a second channel at a second time such that the second time occurs after the first time. In some cases, the memory system may initiate one data transfer over each respective channel at a time, and in some cases, the memory system may initiate two or more data transfers over respective channels at a same time. In some cases, each channel may be associated with a respective timing delay.

### CROSS REFERENCE

The present Application for Patent claims priority to U.S. Patent Application No. 63/588,237 by Yu et al., entitled “TECHNIQUES FOR STAGGERING DATA BURST EVENTS ACROSS CHANNELS,” filed Oct. 5, 2023, which is assigned to the assignee hereof, and which is expressly incorporated by reference in its entirety herein.

### TECHNICAL FIELD

The following relates to one or more systems for memory, including techniques for staggering data burst events across channels.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for staggering data burst events across channels in accordance with examples as disclosed herein.

FIGS. 2A and 2B show examples of timing diagrams that supports techniques for staggering data burst events across channels in accordance with examples as disclosed herein.

FIG. 3 shows an example of a timing diagram that supports techniques for staggering data burst events across channels in accordance with examples as disclosed herein.

FIG. 4 shows an example of a system diagram that supports techniques for staggering data burst events across channels in accordance with examples as disclosed herein.

FIG. 5 shows an example of a process flow that supports techniques for staggering data burst events across channels in accordance with examples as disclosed herein.

FIG. 6 shows a block diagram of a memory system that supports techniques for staggering data burst events across channels in accordance with examples as disclosed herein.

FIG. 7 shows a flowchart illustrating a method or methods that support techniques for staggering data burst events across channels in accordance with examples as disclosed herein.

### DETAILED DESCRIPTION

A memory system may support data transfer, which may be associated with respective standards or protocols for operation of the memory system, as well as corresponding channels (e.g., open non-and (NAND) flash interface (ONFI) channels, DRAM channels, compute express link (CXL) channels, or any combination thereof). For example, the memory system may support transferring data from a first page to a second page over a corresponding channel. In some cases, the memory system may be configured to support data transfer events over multiple channels (e.g., four channels) at a same time, or at least partially overlapping in time (concurrently). In some cases, the number of channels which may be active at a same time may be static and may not be adjusted by the memory system. However, data transfer events over multiple channels may result in high transient current on the channels, which may negatively impact power delivery to the channels, among other issues.

Various aspects of the present disclosure relate to techniques for staggering (e.g., arranging, queueing, processing, assigning, ordering) data burst events across multiple channels. For example, a memory system may offset data transfer events across multiple channels (e.g., ONFI channels, DRAM channels, CXL channels, or any combination thereof) with a timing delay between data transfers over respective channels. For example, the memory system may initiate a first data transfer over a first channel at a first time and implement a timing delay before a second data transfer over a second channel at a second time so that the second time occurs after the first time. In some cases, the memory system may initiate one data transfer over each respective channel at a time, and in some cases, the memory system may initiate two or more data transfers over respective channels at a same time. In some cases, each channel may be associated with a respective timing delay (e.g., a different delay). By staggering the data transfer events over multiple channels with a timing delay associated with one or more channels, the memory system may reduce transient current, which may also decrease power budget requirements that impact power delivery to the channels, among other benefits.

In addition to applicability in memory systems as described herein, techniques for staggering data burst events across channels may be generally implemented to improve the performance of various electronic devices and systems. Some electronic device applications, including high-performance applications (e.g., artificial intelligence (AI) applications, augmented reality (AR) applications, virtual reality (VR) applications, and gaming applications), may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by improving power delivery during transfer and access operations, which may improve response times and power usage, among other benefits.

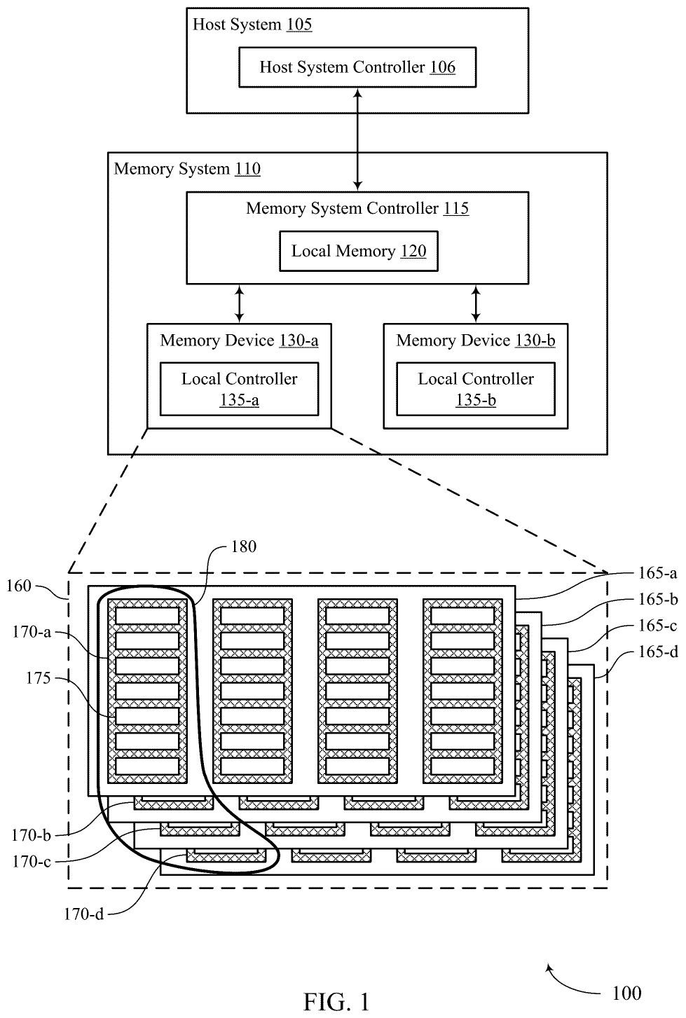

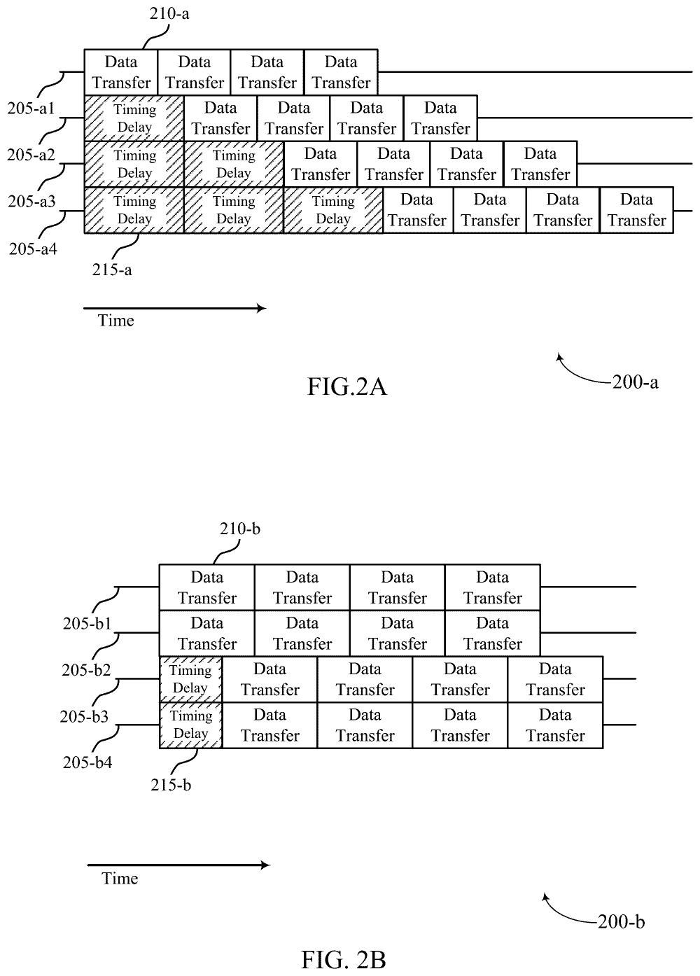

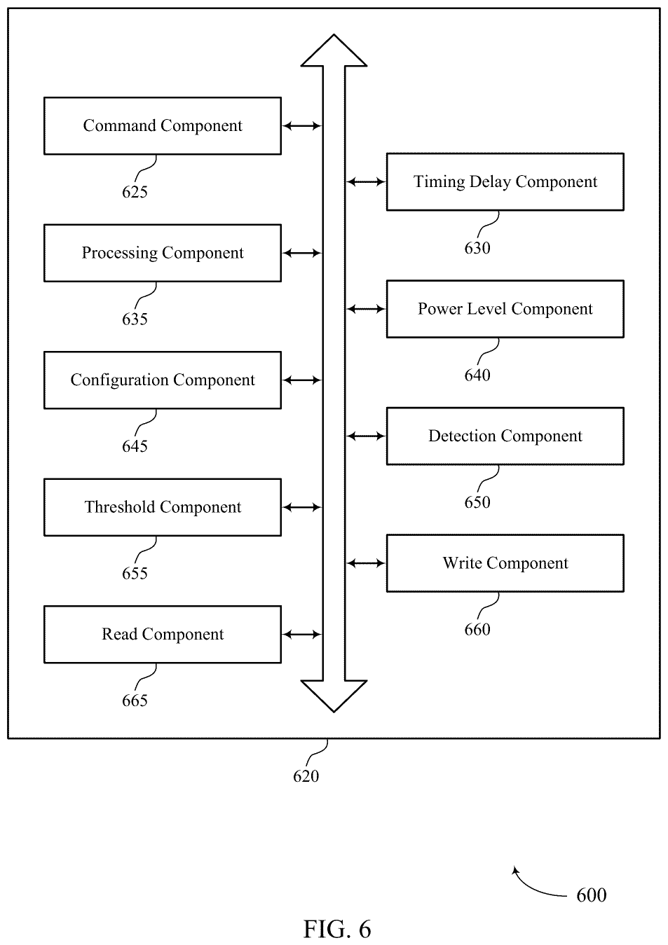

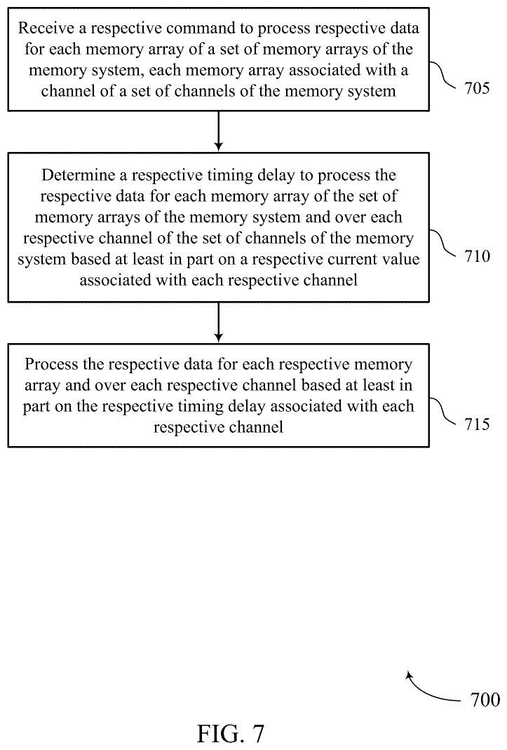

Features of the disclosure are initially described in the context of systems, devices, and circuits with reference to FIGS. 1 through 7. Features of the disclosure are described in the context of timing diagrams, system diagrams, and a process flow with reference to FIGS. 2A through 5. These and other features of the disclosure are further illustrated by and described in the context of an apparatus diagram and flowchart that relate to techniques for staggering data burst events across channels with reference to FIGS. 6 and 7.

FIG. 1 shows an example of a system 100 that supports techniques for staggering data burst events across channels in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support techniques for staggering data burst events across channels. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

The memory system 110 may support data transfer, which may be associated with respective standards or protocols for operation of the memory system 110, as well as corresponding channels (e.g., ONFI channels, DRAM channels, CXL channels, etc.). For example, the memory system 110 may support transferring data from a first page 175 to a second page 175 over a corresponding channel (e.g., a first ONFI channel, a first DRAM channel, a first CXL channel). In some cases, the memory system 110 may be configured to support data transfer events over multiple channels (e.g., four channels) at a same time, or at least partially overlapping in time. In some cases, the number of channels which may be active at a same time may be static and may not be adjusted by the memory system 110. However, data transfer events over multiple channels may result in unwanted transient current on the channels, which may negatively impact power delivery to the channels.

The memory system 110 may offset data transfer events over multiple channels with a timing delay between data transfers over respective channels. For example, the memory system 110 may initiate a first data transfer over a first channel (e.g., a first ONFI channel) at a first time and implement a timing delay before a second data transfer over a second channel (e.g., a second ONFI channel) at a second time, such that the second time occurs after the first time. In some cases, the memory system 110 may initiate one data transfer over each respective channel at a time, and in some cases, the memory system 110 may initiate two or more data transfers over respective channels (e.g., a first ONFI channel, a second ONFI channel) at a same time. In some cases, each channel may be associated with a respective timing delay. By staggering (e.g., arranging, ordering, assigning, allocating, processing) the data transfer events over multiple channels with a timing delay associated with one or more channels, the memory system 110 may reduce transient current, which may also decrease power budget requirements that impact power delivery to the channels.

FIG. 2A shows an example of a timing diagram 200-a that supports techniques for staggering data burst events across channels in accordance with examples as disclosed herein. One or more aspects of the timing diagram 200-a may be implemented by one or more aspects of the system 100. For example, the timing diagram 200-a may be associated with a quantity of channels 205-a (e.g., ONFI channels, DRAM channels, CXL channels, or any combination thereof) for data transfer. For example, a memory system 110, as described with reference to FIG. 1, may include four channels 205-a (e.g., a channel 205-a1, a channel 205-a2, a channel 205-a3, and a channel 205-a4). As the speed of the memory system 110 increases, the current on the channels 205-a and a power rail associated with the memory system may also increase. Additionally or alternatively, if all the channels 205-a are active at a same time a power delivery network associated with the memory system 110 (e.g., the power rail) may observe an increase in current, and in some cases, and increase in noise associated with power. In some cases, the increased current may negatively impact the memory system 110. In some cases, if all the channels 205-a are permitted to be active at a same time, the memory system 110 may reserve a power budget sufficient for all four channels 205-a to be active. In some cases, reserving a significant power budget may affect the allocation of power to other aspects of the memory system 110 and may require more time for the memory system 110 to allocate the power budget.

To decrease negative effects from current on the channels 205-a, the memory system 110 may stagger (e.g., process, order, arrange, queue) channel 205-a activity (e.g., associated with a data transfer) by implementing a timing delay 215-a, which may reduce the peak current associated with the channels 205-a and reduce noise associated with power. For example, each channel 205-a may be associated with a respective memory array (e.g., a NAND array) of the memory system 110, and the memory system 110 may receive a command to process data (e.g., transfer data) for each memory array. For example, the command (e.g., an external transfer command) may indicate data transfer events 210-a to be executed by the memory system 110 for each channel 205-a, where each data transfer event 210-a includes the transfer of a page. In some cases, the memory system 110 may transfer data from a first page memory array of the memory system 110 to a second memory array of the memory system 110. The memory system 110 may determine a respective timing delay 215-a (e.g., a timing delay 215-a associated with each channel 205-a and/or memory array). In some cases, the timing delay 215-a may be based on, or in response to, a current value associated with each respective channel. According to the timing delay 215-a associated with each channel 205-a, the memory system 110 may process the data over each channel 205-a (e.g., by executing the respective data transfer events 210-a) according to the timing delay 215-a associated with each channels.

In some cases, as depicted in FIG. 2A, the memory system 110 may implement the timing delays 215-a such that the channels 205-a may be activated one at a time. For example, the memory system 110 may activate the channel 205-a1 first and may begin to execute data transfer events 210-a. In some cases, the channel 205-a1 may not be associated with a timing delay 215-a or may be associated with a timing delay 215-a of zero. The memory system 110 may then activate the channel 205-a2, followed by the channel 205-a3, then the channel 205-a4. Each channel 205-a may be associated with an increasing quantity of timing delays 215-a, or a timing delay 215-a of increased duration such that the channels 205-a are activated one-by-one. For example, the timing delay 215-a associated with the channel 205-a2 may be different than the timing delay 215-a associated with the channel 205-a3.

In some cases, the timing delay 215-a may consist of a preconfigured time duration (e.g., Δt), and each channel 205-a may be associated with a quantity of timing delays 215-a. For example, the channel 205-a2 may be associated with two timing delays 215-a. In some cases, the preconfigured time duration (e.g., Δt) may be associated with a response time of a power management integrated circuit (PMIC) of the memory system 110. For example, the preconfigured time duration may be no smaller than the target PMIC response time. In some cases, the memory system 110 may receive a timing delay 215-a configuration from a host system. For example, the memory system 110 may receive an indication of the preconfigured time duration from the host system. In some cases, the preconfigured time duration may be configured by firmware.

In some cases, the memory system 110 may configure the timing delays 215-a to reduce a quantity of data transfer events 210-a in parallel (e.g., at least partially overlapping in time). For example, there may be a threshold quantity of channels 205-a that may be active and processing data (e.g., performing data transfer events 210-a) at a same time. For example, the threshold quantity of channels 205-a that may be active at a same time may be three channels 205-a, and the memory system 110 may configure the duration and quantity of timing delays 215-a such that no more than three channels 210-a are active at a same time. For example, the channel 205-a4 may be associated with three timing delays 215-a such that the channel 205-a4 is activated and data transfer events 210-a associated with the channel 205-a4 occur after the channel 205-a1 is no longer active (e.g., inactive). For example, just prior to activating the channel 205-a4, three channels (e.g., the channel 205-a1, the channel 205-a2, and the channel 205-a3) are active, and just after activating the channel 205-a4, three channels (e.g., the channel 205-a2, the channel 205-a3, and the channel 205-a4) are active.

In some cases, the memory system 110 may configure the timing delays 215-a according to an activity (e.g., the data transfer event 210-a). For example, the data transfer event 210-a may be associated with the time duration associated with one page transfer over a channel 205-a, and the timing delay 215-a may be configured to match the time duration associated with the one page transfer. For example, after a first data transfer event 210-a over channel 205-a is complete, a first data transfer event 210-a over the channel 205-a2 may be initiated such that a second data transfer event 210-a begins at a same time as the first data transfer event 210-a over the channel 205-a2. If the timing delay 215-a is associated with the PMIC response time (e.g., Δt) the timing delay 215-a may be rounded up to match the time duration associated with a whole number of activities. (e.g., 1, 2, or 3 activities). The memory system 110 may implement the configured timing delays 215-a to reduce the number of events occurring in parallel (e.g., at least partially overlapping in time). In some cases, the timing delay 215-a duration may be based on a read time, a write time, or any combination thereof.

In some cases, rather than a data transfer event 210-a, the timing delays 215-a may be implemented prior to reading data or writing data over a channel 205-a to the associated memory array.

FIG. 2B shows an example of a timing diagram 200-b that supports techniques for staggering data burst events across channels in accordance with examples as disclosed herein. One or more aspects of the timing diagram 200-a may be implemented by one or more aspects of the system 100 or the timing diagram 200-a. For example, the memory system 110, as described with reference to FIG. 1, may implement timing delays 215-b to stagger (e.g., order, time, process, queue, etc.) data transfer events 210-b such that two or more channels 205-b initiate data transfer events 210-b at a same time. For example, the memory system 110 may first activate a channel 205-b1 and a channel 205-b2 at a same time and initiate data transfer events 210-b. After a timing delay 215-b, the memory system 110 may activate a channel 205-b3 and a channel 205-b4 and perform additional data transfer events 210-b. The timing delay 215-b may include one or more timing delays 215-b and may be a preconfigured time duration (e.g., Δt), may be associated with the duration of one or more events associated with channels 205-b (e.g., the duration of a data transfer event 210-b, a read time, a write time, or any combination thereof), or any combination thereof. In some cases, the memory system 110 may implement a quantity of timing delays 215-b, such that the data transfer events 210-b associated with the channel 205-b1 and the channel 205-b2 are complete before initiating the data transfer events 210-b associated with the channel 205-b3 and the channel 205-b4.

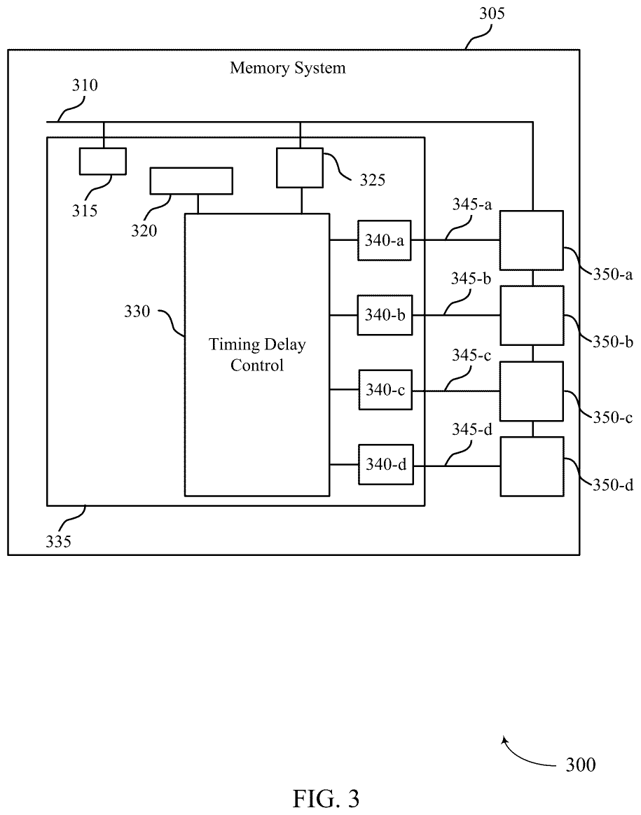

FIG. 3 shows an example of a system diagram 300 that supports techniques for staggering data burst events across channels in accordance with examples as disclosed herein. One or more aspects of the system diagram 300 may be implemented by one or more aspects of the system 100. For example, a memory system 305 may be examples of a memory system 110 as described with reference to FIG. 1. The memory system 305 may dynamically configure a timing delay configuration according to power feedback associated with the memory system 305. The memory system 305 may include a power rail 310, which may be used to power an application specific integrated circuit (ASIC) 335, which may include a core linear voltage regulator 315, a firmware configuration 320, a timing delay control 330, ONFIs 340, and a voltage detector 325. The memory system 305 may also include channels 345 (e.g., ONFI channels) and associated memory arrays 350. The voltage detector 325 may be a voltage detector 325 configured to detect a voltage for determining the timing delay configuration, or a shared voltage detector 325 that may be used for other purposes within the memory system 305.

In some cases, the memory system 305 may implement a default timing delay configuration (e.g., from the firmware configuration 320), but may use the voltage detector 325 to determine whether noise or a power level associated with the power rail 310 satisfies a threshold. For example, if the noise associated with the power rail 310 satisfies (e.g., equal to or greater than) the threshold, the voltage detector 325 may provide feedback to the timing delay control 330. The timing delay control 330 may then adjust (e.g., increment) the timing delay. For example, the timing delay control 330 may increase the timing delay or timing delays associated with ONFI 340-a and corresponding ONFI channel 345-a, ONFI 340-b and corresponding ONFI channel 345-b, ONFI 340-c and corresponding ONFI channel 345-c, and ONFI 340-d and corresponding ONFI channel 345-d while performing data transfers to a memory array 350-a, a memory array 350-b, a memory array 350-c, and a memory array 350-d.

In some cases, the timing delay control 330 may increase the quantity of timing delays or may increase the duration of the timing delays. In some cases, the timing delay control 330 may continue to adjust the timing delay until the voltage detector 325 indicates that the noise associated with the power rail 310 no longer satisfies the threshold. In some cases, the memory system 305 may implement the dynamic timing delay configuration as part of an in-system training design.

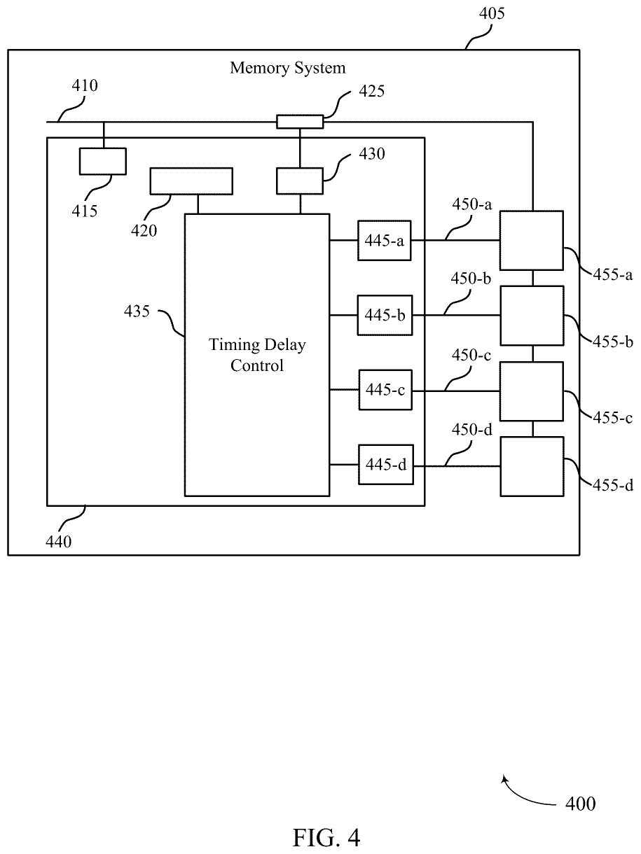

FIG. 4 shows an example of a system diagram 400 that supports techniques for staggering data burst events across channels in accordance with examples as disclosed herein. One or more aspects of the system diagram 400 may be implemented by one or more aspects of the system 100. For example, a memory system 405 may be examples of a memory system 110 as described with reference to FIG. 1. The memory system 405 may dynamically configure a timing delay configuration according to current detector feedback associated with the memory system 405. The memory system 405 may include a power rail 410, which may be used to power an ASIC 440, which may include a core linear voltage regulator 415, a firmware configuration 420, a timing delay control 435, ONFIs 445, and an operation amplifier 430. The memory system 405 may also include a resistor 425, channels 450 (e.g., ONFI channels) and memory arrays 455. The resistor 425 may be coupled with the power rail 410 to detect the voltage drop across the resistor 425. The timing delay control 435 may determine the current amplitude or noise associated with the power rail 410 according to the voltage drop across the resistor 425 detected by the operational amplifier 430.

According to the current amplitude or noise associated with the power rail 410, the timing delay control 435 may adjust a timing delay associated with channels 450. For example, if the current amplitude or noise associated with the power rail 410 satisfies (e.g., greater than or equal to) a threshold, the timing delay control 435 may adjust (e.g., increase) the or timing delays associated with ONFI 445-a and corresponding ONFI channel 450-a, ONFI 445-b and corresponding ONFI channel 450-b, ONFI 445-c and corresponding ONFI channel 450-c, and ONFI 450-d and corresponding ONFI channel 450-d while performing data transfers to memory array 455-a, memory array 455-b, memory array 455-c, and memory array 455-d. In some cases, the resistor 425 may be a low-resistance (e.g., 5 mOhm) resistor 425 to decrease the effect on the power rail margin.

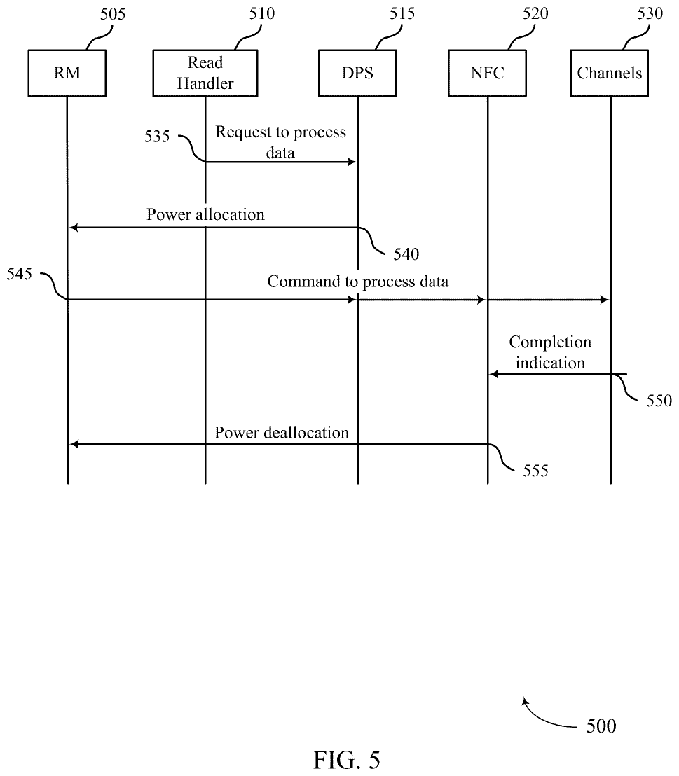

FIG. 5 shows an example of a process flow 500 that supports techniques for staggering data burst events across channels in accordance with examples as disclosed herein. In some cases, the process flow 500 may be implemented by aspects of the system 100 as described with reference to FIG. 1. In some cases, the process flow 500 may implement aspects of the timing diagram 200-a and the timing diagram 200-b as described with reference to FIGS. 2A and 2B, respectively. In some other cases, the process flow 500 may implement aspects of the system diagram 300 and the system diagram 400 as described with reference to FIGS. 3 and 4, respectively. In the following description of the process flow 500, the operations may be performed in a different order than the order shown. Some operations may also be left out of the process flow 500, or other operations may be added to the process flow 500. Although some operations or communications may be shown to occur at different times for discussion purposes, these operations may occur at the same time. The process flow 500 may include a resource manager 505, a read handler 510, a dynamic power switch 515, a near field communicator 520, and channels 530.

Aspects of the process flow 500 may be implemented by a controller, among other components. Additionally or alternatively, aspects of the process flow 500 may be implemented as instructions stored in memory (e.g., firmware stored in a memory coupled with a timing delay control). For example, the instructions, when executed by a controller (e.g., the timing delay control), may cause the controller to perform the operations of the process flow 500.

At 535, a request may be exchanged (e.g., transmitted, received). For example, the read handler 510 may transmit, and the dynamic power switch 515 may, receive a request to process data. The request to process data may include a request to perform one or more data transfers (e.g., page transfers), read operations, write operations, or any combination thereof. In some cases, the request to process data may be associated with one or more channels 530 (e.g., ONFI channels, DRAM channels, CXL channels, or any combination thereof).

At 540, a power allocation may be exchanged (e.g., transmitted, received). For example, the dynamic power switch 515 may transmit and the resource manager 505 may receive a power allocation to perform the request at 335. According to the power allocation the resource manager 505 may determine a power budget for the channels 530 and a corresponding timing delay configuration as described with reference to FIGS. 2A and 2B.

At 545, a command may be received (e.g., a write command, an access command, a read command). For example, according to the power allocation received at 540, the resource manager 505 may transmit and the dynamic power switch 515, the near field communicator 520, and the channels 530 may receive a command to process data. In some cases, the command to process data may include a command to process respective data for each memory array of a set of memory array of the memory system, where each memory array is associated with a channel of the set of channels 530. The data may be processed according to the timing delay configuration. In some cases, the memory system may adjust the timing delay configuration while performing the command to process data, as described with reference to FIGS. 3 and 4. In some cases, the resource manager 505 may ensure that the command to process data at 545 is executed by the channels 530 such that the command to process data is executed to satisfy a timing delay after a previous set of one or more data transfers or completion indications associated with previous data transfers.

At 550, the channels 530 may transmit and the near field communicator 520 may receive a completion indication once the channels have executed the command to process data. At 555, according to the completion indication at 550, the near field communicator 520 may transmit and the resource manager 505 may receive a power deallocation and may deallocate power.

FIG. 6 shows a block diagram 600 of a memory system 620 that supports techniques for staggering data burst events across channels in accordance with examples as disclosed herein. The memory system 620 may be an example of aspects of a memory system as described with reference to FIGS. 1 through 5. The memory system 620, or various components thereof, may be an example of means for performing various aspects of techniques for staggering data burst events across channels as described herein. For example, the memory system 620 may include a command component 625, a timing delay component 630, a processing component 635, a power level component 640, a configuration component 645, a detection component 650, a threshold component 655, a write component 660, a read component 665, or any combination thereof. Each of these components may communicate, directly or indirectly, with one another (e.g., via one or more buses).

The memory system 620 may support operating a memory system in accordance with examples as disclosed herein. The command component 625 may be configured as or otherwise support a means for receiving a respective command to process respective data for each memory array of a set of memory arrays of the memory system, each memory array associated with a channel of a set of channels of the memory system. The timing delay component 630 may be configured as or otherwise support a means for determining a respective timing delay to process the respective data for each memory array of the set of memory arrays of the memory system and over each respective channel of the set of channels of the memory system based at least in part on a respective current value associated with each respective channel. The processing component 635 may be configured as or otherwise support a means for processing the respective data for each respective memory array and over each respective channel based at least in part on the respective timing delay associated with each respective channel.

In some examples, the timing delay component 630 may be configured as or otherwise support a means for determining the respective timing delay based at least in part on a threshold quantity of channels of the set of channels of the memory system processing the respective data during a same time.

In some examples, to support processing the respective data for each respective memory array and over each respective channel, the processing component 635 may be configured as or otherwise support a means for processing the respective data for a first memory array and over a first channel in response to a first timing delay associated with the first channel. In some examples, to support processing the respective data for each respective memory array and over each respective channel, the processing component 635 may be configured as or otherwise support a means for processing the respective data for a second memory array and over a second channel based at least in part on processing the respective data for the first memory array and in response to a second timing delay associated with the second channel, where the first timing delay is different than the second timing delay.

In some examples, to support processing the respective data for each respective memory array and over each respective channel, the processing component 635 may be configured as or otherwise support a means for processing the respective data for a first memory array and over a first channel in response to the respective timing delay associated with the first channel. In some examples, to support processing the respective data for each respective memory array and over each respective channel, the processing component 635 may be configured as or otherwise support a means for processing the respective data for a second memory array and over a second channel in response to the respective timing delay associated with the second channel, where the respective timing delay associated with the first channel and the respective timing delay associated with the second channel is the same.

In some examples, the respective timing delay includes a preconfigured time duration and each channel of the set of channels of the memory system is associated with a quantity of timing delays.

In some examples, the preconfigured time duration is based at least in part on a response time of a power management integrated circuit of the memory system.

In some examples, the power level component 640 may be configured as or otherwise support a means for determining a power level associated with a power rail of the memory system. In some examples, the timing delay component 630 may be configured as or otherwise support a means for determining the respective timing delay based at least in part on the power level associated with the power rail of the memory system.

In some examples, the threshold component 655 may be configured as or otherwise support a means for determining whether the power level associated with the power rail of the memory system satisfies a threshold. In some examples, the timing delay component 630 may be configured as or otherwise support a means for adjusting the respective timing delay based at least in part on determining that the power level associated with the power rail of the memory system satisfies the threshold.

In some examples, the configuration component 645 may be configured as or otherwise support a means for receiving a configuration indicating a threshold quantity of channels of the set of channels of the memory system to be active during a duration. In some examples, the timing delay component 630 may be configured as or otherwise support a means for determining the respective timing delay based at least in part on the configuration.

In some examples, to support receiving the respective command to process respective data for each memory array of the set of memory arrays of the memory system, the command component 625 may be configured as or otherwise support a means for receiving the respective command to transfer data from a first memory array of the set of memory arrays of the memory system to a second memory array of the set of memory arrays of the memory system.

In some examples, to support receiving the respective command to process respective data for each memory array of the set of memory arrays of the memory system, the command component 625 may be configured as or otherwise support a means for receiving the respective command to write the respective data to each memory array of the set of memory arrays of the memory system.

In some examples, to support processing the respective data for each respective memory array and over each respective channel, the write component 660 may be configured as or otherwise support a means for writing the respective data to each respective memory array.

In some examples, to support receiving the respective command to process respective data for each memory array of the set of memory arrays of the memory system, the command component 625 may be configured as or otherwise support a means for receiving the respective command to read the respective data from each memory array of the set of memory arrays of the memory system.

In some examples, to support processing the respective data for each respective memory array and over each respective channel, the read component 665 may be configured as or otherwise support a means for reading the respective data from each respective memory array.

In some examples, the respective timing delay to process the respective data for each memory array of the set of memory arrays of the memory system and over each respective channel of the set of channels of the memory system is less than or equal to a respective duration associated with a respective external transfer of a respective page for each memory array of the set of memory arrays of the memory system and over each respective channel of the set of channels of the memory system.

In some examples, the set of memory arrays includes a NAND arrays, a set of DRAM arrays, or any combination thereof. In some examples, the set of channels includes a set of ONFI channels, a set of DRAM channels, a set of CXL channels, or any combination thereof.

In some examples, the detection component 650 may be configured as or otherwise support a means for detecting one or more of a voltage, a current, or any combination thereof. In some examples, the timing delay component 630 may be configured as or otherwise support a means for determining the respective timing delay is based at least in part on one or more of the voltage, the current, or any combination thereof.

In some examples, the respective command includes an external transfer command. In some examples, the respective data includes a page.

FIG. 7 shows a flowchart illustrating a method 700 that supports techniques for staggering data burst events across channels in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the wireless memory system may perform aspects of the described functions using special-purpose hardware.

At 705, the method may include receiving a respective command to process respective data for each memory array of a set of memory arrays of the memory system, each memory array associated with a channel of a set of channels of the memory system. The operations of 705 may be performed in accordance with examples as disclosed herein. In some examples, aspects of the operations of 705 may be performed by a command component 625 as described with reference to FIG. 6.

At 710, the method may include determining a respective timing delay to process the respective data for each memory array of the set of memory arrays of the memory system and over each respective channel of the set of channels of the memory system based at least in part on a respective current value associated with each respective channel. The operations of 710 may be performed in accordance with examples as disclosed herein. In some examples, aspects of the operations of 710 may be performed by a timing delay component 630 as described with reference to FIG. 6.

At 715, the method may include processing the respective data for each respective memory array and over each respective channel based at least in part on the respective timing delay associated with each respective channel. The operations of 715 may be performed in accordance with examples as disclosed herein. In some examples, aspects of the operations of 715 may be performed by a processing component 635 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a respective command to process respective data for each memory array of a set of memory arrays of the memory system, each memory array associated with a channel of a set of channels of the memory system; determining a respective timing delay to process the respective data for each memory array of the set of memory arrays of the memory system and over each respective channel of the set of channels of the memory system based at least in part on a respective current value associated with each respective channel; and processing the respective data for each respective memory array and over each respective channel based at least in part on the respective timing delay associated with each respective channel.

Aspect 2: The method, apparatus, or non-transitory computer-readable medium of aspect 1, where determining the respective timing delay is based at least in part on a threshold quantity of channels of the set of channels of the memory system processing the respective data during a same time.

Aspect 3: The method, apparatus, or non-transitory computer-readable medium of any of aspects 1 through 2, where processing the respective data for each respective memory array and over each respective channel includes operations, features, circuitry, logic, means, or instructions, or any combination thereof for processing the respective data for a first memory array and over a first channel in response to a first timing delay associated with the first channel and processing the respective data for a second memory array and over a second channel based at least in part on processing the respective data for the first memory array and in response to a second timing delay associated with the second channel, where the first timing delay is different than the second timing delay.

Aspect 4: The method, apparatus, or non-transitory computer-readable medium of any of aspects 1 through 2, where processing the respective data for each respective memory array and over each respective channel includes operations, features, circuitry, logic, means, or instructions, or any combination thereof for processing the respective data for a first memory array and over a first channel in response to the respective timing delay associated with the first channel and processing the respective data for a second memory array and over a second channel in response to the respective timing delay associated with the second channel, where the respective timing delay associated with the first channel and the respective timing delay associated with the second channel is the same.

Aspect 5: The method, apparatus, or non-transitory computer-readable medium of any of aspects 1 through 4, where the respective timing delay includes a preconfigured time duration and each channel of the set of channels of the memory system is associated with a quantity of timing delays.

Aspect 6: The method, apparatus, or non-transitory computer-readable medium of aspect 5, where the preconfigured time duration is based at least in part on a response time of a power management integrated circuit of the memory system.

Aspect 7: The method, apparatus, or non-transitory computer-readable medium of any of aspects 1 through 6, further including operations, features, circuitry, logic, means, or instructions, or any combination thereof for determining a power level associated with a power rail of the memory system, where determining the respective timing delay is based at least in part on the power level associated with the power rail of the memory system.

Aspect 8: The method, apparatus, or non-transitory computer-readable medium of aspect 7, further including operations, features, circuitry, logic, means, or instructions, or any combination thereof for determining whether the power level associated with the power rail of the memory system satisfies a threshold and adjusting the respective timing delay based at least in part on determining that the power level associated with the power rail of the memory system satisfies the threshold.

Aspect 9: The method, apparatus, or non-transitory computer-readable medium of any of aspects 1 through 8, further including operations, features, circuitry, logic, means, or instructions, or any combination thereof for receiving a configuration indicating a threshold quantity of channels of the set of channels of the memory system to be active during a duration, where determining the respective timing delay is based at least in part on the configuration.

Aspect 10: The method, apparatus, or non-transitory computer-readable medium of any of aspects 1 through 9, where receiving the respective command to process respective data for each memory array of the set of memory arrays of the memory system includes operations, features, circuitry, logic, means, or instructions, or any combination thereof for receiving the respective command to transfer data from a first memory array of the set of memory arrays of the memory system to a second memory array of the set of memory arrays of the memory system.

Aspect 11: The method, apparatus, or non-transitory computer-readable medium of any of aspects 1 through 10, where receiving the respective command to process respective data for each memory array of the set of memory arrays of the memory system includes operations, features, circuitry, logic, means, or instructions, or any combination thereof for receiving the respective command to write the respective data to each memory array of the set of memory arrays of the memory system.

Aspect 12: The method, apparatus, or non-transitory computer-readable medium of aspect 11, where processing the respective data for each respective memory array and over each respective channel includes operations, features, circuitry, logic, means, or instructions, or any combination thereof for writing the respective data to each respective memory array.

Aspect 13: The method, apparatus, or non-transitory computer-readable medium of any of aspects 1 through 10, where receiving the respective command to process respective data for each memory array of the set of memory arrays of the memory system includes operations, features, circuitry, logic, means, or instructions, or any combination thereof for receiving the respective command to read the respective data from each memory array of the set of memory arrays of the memory system.

Aspect 14: The method, apparatus, or non-transitory computer-readable medium of aspect 13, where processing the respective data for each respective memory array and over each respective channel includes operations, features, circuitry, logic, means, or instructions, or any combination thereof for reading the respective data from each respective memory array.

Aspect 15: The method, apparatus, or non-transitory computer-readable medium of any of aspects 1 through 14, where the respective timing delay to process the respective data for each memory array of the set of memory arrays of the memory system and over each respective channel of the set of channels of the memory system is less than or equal to a respective duration associated with a respective external transfer of a respective page for each memory array of the set of memory arrays of the memory system and over each respective channel of the set of channels of the memory system.

Aspect 16: The method, apparatus, or non-transitory computer-readable medium of any of aspects 1 through 15, where the set of memory arrays includes a set of NAND arrays, a set of DRAM arrays, or any combination thereof and the set of channels includes a set of ONFI channels, a set of DRAM channels, a set of CXL channels, or any combination thereof.

Aspect 17: The method, apparatus, or non-transitory computer-readable medium of any of aspects 1 through 16, further including operations, features, circuitry, logic, means, or instructions, or any combination thereof for detecting one or more of a voltage, a current, or any combination thereof, where determining the respective timing delay is based at least in part on one or more of the voltage, the current, or any combination thereof.

Aspect 18: The method, apparatus, or non-transitory computer-readable medium of any of aspects 1 through 17, where the respective command includes an external transfer command and the respective data includes a page.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus, comprising:
a memory device; and
a controller coupled with the memory device and configured to cause the apparatus to:
receive a respective command to process respective data for each memory array of a set of memory arrays of a memory system, each memory array associated with a channel of a set of channels of the memory system;
determine a respective timing delay to process the respective data for each memory array of the set of memory arrays of the memory system and over each respective channel of the set of channels of the memory system based at least in part on a respective current value associated with each respective channel; and
process the respective data for each respective memory array and over each respective channel based at least in part on the respective timing delay associated with each respective channel.

2. The apparatus of claim 1, wherein determining the respective timing delay is based at least in part on a threshold quantity of channels of the set of channels of the memory system processing the respective data during a same time.

3. The apparatus of claim 1, wherein, to process the respective data for each respective memory array and over each respective channel, the controller is configured to cause the apparatus to:
process the respective data for a first memory array and over a first channel in response to a first timing delay associated with the first channel; and
process the respective data for a second memory array and over a second channel based at least in part on processing the respective data for the first memory array and in response to a second timing delay associated with the second channel,
wherein the first timing delay is different than the second timing delay.

4. The apparatus of claim 1, wherein, to process the respective data for each respective memory array and over each respective channel, the controller is configured to cause the apparatus to:
process the respective data for a first memory array and over a first channel in response to the respective timing delay associated with the first channel; and
process the respective data for a second memory array and over a second channel in response to the respective timing delay associated with the second channel,
wherein the respective timing delay associated with the first channel and the respective timing delay associated with the second channel is the same.

5. The apparatus of claim 1, wherein the respective timing delay comprises a preconfigured time duration and each channel of the set of channels of the memory system is associated with a quantity of timing delays.

6. The apparatus of claim 5, wherein the preconfigured time duration is based at least in part on a response time of a power management integrated circuit of the memory system.

7. The apparatus of claim 1, wherein the controller is further configured to cause the apparatus to:
determine a power level associated with a power rail of the memory system,
wherein determining the respective timing delay is based at least in part on the power level associated with the power rail of the memory system.

8. The apparatus of claim 7, wherein the controller is further configured to cause the apparatus to:
determine whether the power level associated with the power rail of the memory system satisfies a threshold; and
adjust the respective timing delay based at least in part on determining that the power level associated with the power rail of the memory system satisfies the threshold.

9. The apparatus of claim 1, wherein the controller is further configured to cause the apparatus to:
receive a configuration indicating a threshold quantity of channels of the set of channels of the memory system to be active during a duration,
wherein determining the respective timing delay is based at least in part on the configuration.

10. The apparatus of claim 1, wherein, to receive the respective command to process respective data for each memory array of the set of memory arrays of the memory system, the controller is configured to cause the apparatus to:
receive the respective command to transfer data from a first memory array of the set of memory arrays of the memory system to a second memory array of the set of memory arrays of the memory system.

11. The apparatus of claim 1, wherein, to receive the respective command to process respective data for each memory array of the set of memory arrays of the memory system, the controller is configured to cause the apparatus to:
receive the respective command to write the respective data to each memory array of the set of memory arrays of the memory system.

12. The apparatus of claim 11, wherein, to process the respective data for each respective memory array and over each respective channel, the controller is configured to cause the apparatus to:
write the respective data to each respective memory array.

13. The apparatus of claim 1, wherein, to receive the respective command to process respective data for each memory array of the set of memory arrays of the memory system, the controller is configured to cause the apparatus to:
receive the respective command to read the respective data from each memory array of the set of memory arrays of the memory system.

14. The apparatus of claim 13, wherein, to process the respective data for each respective memory array and over each respective channel, the controller is configured to cause the apparatus to:
read the respective data from each respective memory array.

15. The apparatus of claim 1, wherein the respective timing delay to process the respective data for each memory array of the set of memory arrays of the memory system and over each respective channel of the set of channels of the memory system is less than or equal to a respective duration associated with a respective external transfer of a respective page for each memory array of the set of memory arrays of the memory system and over each respective channel of the set of channels of the memory system.

16. The apparatus of claim 1, wherein the set of memory arrays comprises a set of not-and (NAND) arrays, a set of dynamic random-access memory (DRAM) arrays, or any combination thereof, and the set of channels comprises a set of open not-and (NAND) flash interface working group (ONFI) channels, a set of DRAM channels, a set of compute express link (CXL) channels, or any combination thereof.

17. The apparatus of claim 1, wherein the controller is further configured to cause the apparatus to:
detect one or more of a voltage, a current, or any combination thereof,
wherein determining the respective timing delay is based at least in part on one or more of the voltage, the current, or any combination thereof.

18. The apparatus of claim 1, wherein the respective command comprises an external transfer command, and the respective data comprises a page.

19. A non-transitory computer-readable medium storing code comprising instructions which, when executed by a processor of an electronic device, cause the electronic device to:
receive a respective command to process respective data for each memory array of a set of memory arrays of a memory system, each memory array associated with a channel of a set of channels of the memory system;
determine a respective timing delay to process the respective data for each memory array of the set of memory arrays of the memory system and over each respective channel of the set of channels of the memory system based at least in part on a respective current value associated with each respective channel; and
process the respective data for each respective memory array and over each respective channel based at least in part on the respective timing delay associated with each respective channel.

20. A method for operating a memory system, comprising:
receiving a respective command to process respective data for each memory array of a set of memory arrays of a memory system, each memory array associated with a channel of a set of channels of the memory system;
determining a respective timing delay to process the respective data for each memory array of the set of memory arrays of the memory system and over each respective channel of the set of channels of the memory system based at least in part on a respective current value associated with each respective channel; and
processing the respective data for each respective memory array and over each respective channel based at least in part on the respective timing delay associated with each respective channel.
